(19) United States
(12) Patent Application Publication
(10) Pub. No.: US 2010/0011818 A1
(43) Pub. Date: Jan. 21, 2010

(54) Safety switch

(75) Inventors: Etsurou Komori, Osaka (JP); Takao Fukui, Osaka (JP); Takeo Yasui, Osaka (JP); Masaki Nobuhiro, Osaka (JP)

Correspondence Address: JORDAN AND HAMBURG LLP, 122 EAST 42ND STREET, SUITE 4000, NEW YORK, NY, 10168, US

(73) Assignee: IDEC CORPORATION, Osaka-shi (JP)

(21) Appl. No.: 11/919,375

(22) PCT Filed: Apr. 5, 2006
(86) PCT No.: PCT/JP2006/307223

§ 371 Date: Oct. 25, 2007

(30) Foreign Application Priority Data
Apr. 26, 2005 (JP) 2005-127454

(51) Int. Cl. G05G 5/00

(52) U.S. Cl. 70/181

(57) ABSTRACT

A safety switch is provided in which the open-close condition of a switching contact provided in a lock mechanism is reliably switched in a manner coupled with a motion of a lock member between a lock position and a unlock position. Since a link member, which directly and simultaneously switches the open-close conditions of normally-open and normally-closed switching contacts pursuant to the motion of a lock member, is provided, the open-close conditions of the normally-open and normally-close switching contacts can be switched reliably in a coupled manner with the motion of the lock member between the lock position and the unlock position. As a result, for example, by monitoring the open-close conditions of the normally-open and normally-close switching contacts, it is possible to determine to which of the lock position and the unlock position the lock member has moved, that is, which of the locked state and the unlocked state the rotation of the drive cam is in.

### TECHNICAL FIELD

The present invention relates to a safety switch mounted on a peripheral wall surface of a protective door of, for example, industrial machinery etc., and stopping a supply of power to the industrial machinery etc. when the protective door is opened.

### BACKGROUND ART

Conventionally, the protective door etc. of industrial machinery has been provided with a safety switch preventing the machinery from being driven in situations where the protective door is not fully closed in order to avert accidents wherein a worker is injured as a result of entrapment in the machinery. As an example of this type of safety switch, the safety switch disclosed in Patent Document 1 is provided with a lock mechanism that mechanically locks an actuator in the safety switch after the actuator having been inserted thereinto, thus preventing extraction of the operating key.

The safety switch provided with this lock mechanism is configured such that, for example, by providing an actuator in a protective door in the form of protrusion, and the switch main unit in the position where the actuator is inserted into the switch main unit through an insertion opening with the protective door closed, the actuator is inserted into the switch main unit through the insertion opening when the protective door is closed. Then, a cam-like plate (driving cam) is rotated as a result of insertion of the actuator, and as a result of the cam-like plate rotating, a cam follower pin that is in sliding contact along the respective cam openings are guided to a guide portion of a pin guide plate. A switching member, which integrally includes the cam follower pin, is caused to move as well so that a switching section is switched.

Also when the cam-like plate rotates as a result of insertion of the actuator, a locking bar of a lock lever (lock member) that is rotationally urged by an elastic member constantly abuts while making sliding contact with the cam-like plate in a substantially circular shape. When the cam-like plate is rotated to the position capable of switching the switch section, the lock lever rotates so that the locking bar opposes and engages with an engaging step section. Accordingly, the rotation of the cam-like plate as a result of motion of the actuator toward a withdrawal direction is blocked by the engaging step section abutting the locking bar, which mechanically locks the actuator to prohibit motion thereof toward a withdrawal direction, namely opening of a protective door. Then, for example, when the industrial machinery stops and a solenoid provided in a solenoid unit of the lock mechanism is operated due to input of a signal detecting the stoppage, the lock lever is operated against a urging force of the elastic member by the working rod of the solenoid, and the locking bar moves away from the engaging step section, thereby releasing the lock.

Next, the solenoid unit is described in detail with reference to FIG. 13. As shown in FIG. 13, a normally-open switching contact 124 and a normally-closed switching contact 125, which open and close in a manner coupled with the motion of the working rod 127a that moves as a result of the solenoid 127 being operated, and respectively become in an open and a closed in a locked state, which is a condition when a supply of power to the solenoid 127 is shut off. Also, an operation member 127b is connected to the working rod 127a, and the operation member 127b is engaged with a lock lever 127c. The operation member 127b moves pursuant to the motion of the working rod 127a that moves as a result of the solenoid 127 being operated, and the lock lever 127c moves in a coupled manner with the motion of the operation member 127b, and the engagement condition between the locking bar of the lock lever 127c and the engaging step section is released. It should be noted that FIG. 13 is a cross-sectional view showing a solenoid unit of a conventional safety switch.

Operations of the normally-open and normally-closed switching contacts 124 and 125, the operation member 127b, and the lock lever 127c are described in detail. Each of the normally-open and normally-closed switching contacts 124 and 125 includes a movable contact and a fixed contact. They are also provided with a first and a second link member, respectively, for moving the movable contacts by transmitting the motion of the working rod 127a of the solenoid 127 to the movable contacts. When the solenoid 127 is energized, the working rod 127a moves in the direction of the arrow ON and along with this the first and second link members also move in the direction of the arrow ON, and accordingly the movable contacts also move in the direction of the arrow ON. As a result, the movable contact and the fixed contact of the normally-open switching contact 124 contact each other, thereby putting the normally-open switching contact 124 in a closed condition, while the movable contact and the fixed contact of the normally-closed switching contact 125 are separated, thereby putting the normally-closed switching contact 125 in an open condition. Then, along with the working rod 127a moving in the direction of the arrow ON, the operation member 127b also moves in the direction of arrow ON. Pursuant to the motion of the operation member 127b in the direction of the arrow ON, the lock lever 127c engaged with the operation member 127b moves so that the safety switch becomes an unlocked state. Also, when a supply of power to the solenoid 127 is cutoff, along with the working rod 127a moving in the direction opposite to the arrow ON due to the urging force of a return spring (not shown), the first and second link members and the movable contacts move in the same direction as the moving direction of the working rod 127a, thereby putting the normally-open and normally-closed switching contacts 124 and 125 in an open and a closed condition, respectively. In addition, the operation member 127b moves in the same direction as the working rod 127a, and the lock lever 127c moves in a coupled manner with the motion of the operation member 127b. As a result, the locking bar of the lock lever 127c and the engaging step section become engaged so that the safety switch becomes a locked state. By monitoring the open-close conditions of the normally-open and normally-closed switching contacts 124 and 125, the lock condition of the lock mechanism can be detected.

Patent Document 1: JP H6-76675A ([0008] to [0009], FIG. 1)

### DISCLOSURE OF INVENTION

### Problem to be Solved by the Invention

Incidentally, in the above-described conventional safety switch, the open-close conditions of the normally-open and normally-closed switching contacts 124 and 125 are switched as a result of the working rod 127a, the operation member 127b and the lock lever 127c moving in a coupled manner, so that the lock condition of the lock mechanism can be detected. Thus, in the conventional safety switch, since the lock member (lock lever 127c) is not directly connected to the first and second link members (the normally-open and normally-closed switching contacts 124 and 125), the following problem has sometimes occurred. That is, since the lock member is connected to the first and second link members via the working rod 127a and the operation member 127b, for example, the engagement condition between the operation member 127b and the lock member may be released or become loose, so that the lock member and the first and second link members may fail to move in a coupled manner. As a result, when the solenoid 127 is energized, the operation member 127b and the lock member do not move in a coupled manner, so that the open-close conditions of the normally-open and normally-closed switching contacts 124 and 125 are normally switched so as to indicate the unlocked state, although the engagement condition between the lock member and the engaging step section is not released. In addition, when a supply of power to the solenoid 127 is shutoff, the operation member 127b and the lock member do not move in a coupled manner, so that the normally-open and normally-closed switching contacts 124 and 125 are normally switched so as to indicate the locked state, although the engagement condition between the lock member and the engaging step section is released. In this manner, even if a problem has occurred to the connection between the lock member and both switching contacts, the switching contacts operate normally depending on the condition of energization of the solenoid 127. Therefore, it has been sometimes impossible to determine whether the lock mechanism is in a locked state or an unlocked state only by monitoring the open-close conditions of the normally-open and normally-closed switching contacts 124 and 125.

The present invention has been achieved in view of the above-described problems, and the object thereof is to provide a safety switch in which the open-close conditions of the switching contacts provided in the lock mechanism are reliably switched in a manner coupled with the motion of the lock member between a lock position and an unlock position.

### Means for Solving Problems

As a means of resolving the above-explained problems, the safety switch according to the present invention is a safety switch provided with an actuator capable of freely entering/withdrawing from an operation section of a switch main unit, in which a switch section side switching contact becomes an open condition/a closed condition as result of an operating rod provided in a switch section reciprocating in response to the entry/withdrawal of the actuator, so that the entry/withdrawal of the actuator is detected, includes a drive cam provided in the operation section and capable of freely rotating, and a lock mechanism provided in a lock mechanism section of the switch main unit that locks rotation of the drive cam, wherein the drive cam rotates forward and backward in response to the entry/withdrawal of the actuator with respect to the operation section, and the operating rod reciprocates due to the forward and backward rotation, and the lock mechanism includes a lock member provided capable of freely moving between a lock position and an unlock position, that moves to the lock position when the actuator is in the entry condition so as to lock the rotation of the drive cam, and moves to the unlock position so as to release the locked state of the rotation of the drive cam; a drive section that moves the lock member; at least one lock mechanism side switching contact; and a link member that switches an open-close condition of the lock mechanism side switching contact in a manner coupled with the motion of the lock member. (Claim 1)

With such a configuration, the drive cam rotates forward and backward pursuant to entry and withdrawal of the actuator with respect to the operation section of the switch main unit, and the operating rod reciprocates pursuant to this rotation of the drive cam in both directions, so that the switch section side switching contacts open/close pursuant to the reciprocation of the operating rod. Then, when the actuator is in an entry state, the rotation of the drive cam is locked by the drive section of the lock mechanism causing the lock member to move to the lock position, and the locked state of the rotation of the drive cam is released by causing the lock member to move to the unlock position. In addition, since the link member directly switches the open-close conditions of the lock mechanism side switching contacts provided in the lock mechanism in a manner pursuant to the motion of the lock member, the open-close conditions of the lock mechanism side switching contacts can be reliably switched in a manner coupled with the motion of the lock member between the lock position and the unlock position. Further, since the link member switches the open-close conditions of the lock mechanism side switching contacts provided in the lock mechanism in a manner coupled with the motion of the lock member between the lock position and the unlock position, for example, by monitoring the open-close conditions of the lock mechanism side switching contacts provided in the lock mechanism, it is possible to determine to which of the lock position and the unlock position the lock member has moved, that is, which of the locked state and the unlocked state the rotation of the drive cum is in.

Also, a configuration can also be such that the lock mechanism includes two or more the lock mechanism side switching contacts, and the link member is provided connecting the lock member and respective movable contacts of the lock mechanism side switching contacts. (Claim 2) With such a configuration, since the lock member is directly connected to the respective movable contacts of two or more lock mechanism side switching contacts via the link member, the link member moves pursuant to the motion of the lock member, and the movable contacts of the lock mechanism side switching contacts reliably move pursuant to the motion of the link member. As a result, the open-close conditions of these lock mechanism side switching contacts can be reliably and simultaneously switched in a manner coupled with the motion of the lock member between the lock position and the unlock position. Therefore, for example, as so-called double countermeasures, it can be reliably determined which of the locked state and the unlocked state the rotation of the drive cum is in, by simultaneously monitoring the open-close conditions of these lock mechanism side switching contacts.

Also, a configuration can also be such that the lock mechanism includes a normally-open switching contact and a normally-closed switching contact as the two or more lock mechanism side switching contacts, and the link member is provided connecting the lock member and respective movable contacts of the normally-open switching contact and the normally-closed switching contact. (Claim 3). With such a configuration, since the lock member is connected to the link member, the link member moves pursuant to the motion of the lock member. The movable contacts of the normally-open and normally-closed switching contacts are connected to the link member, and therefore the respective movable contacts of the normally-open and normally-closed switching contacts simultaneously move pursuant to the motion of the link member. For this reason, the open-close conditions of the normally-open and normally-closed switching contacts can be reliably and simultaneously switched in a manner coupled with the motion of the lock member. In addition, for example, when fusion occurs to one of the normally-open and normally-closed switching contacts so that the movable contact thereof cannot move normally, the link member connected to the fused movable contact cannot move either. Accordingly, the movable contact of the other normal switching contact connected in a similar manner to the link member does not move either. Thus, when a problem occurs to one of the switching contacts, the other switching contact can be prevented from operating normally, which makes it possible that the normally-open and normally-closed switching contacts reliably maintain the opposite open-close conditions.

A configuration can also be such that the drive section includes a hinge-type electromagnet provided in the lock mechanism section, with a working member displaced due to electromagnetic force of attraction generated by energization, and a transmission section that moves the lock member by transmitting the displacement of the working member to the lock member. (Claim 4). With such a configuration, the drive section transmits to the lock member via the transmission section the displacement of the working member caused by the electromagnetic force of attraction generated by energizing the hinge-type electromagnet, so as to move the lock member. In this way, since the displacement of the working member caused by the electromagnetic force of attraction generated by energizing the hinge-type electromagnet is transmitted to the lock member via the transmission section so as to move the lock member, in comparison to usage of the electromagnetic force of attraction in a straight-line fashion such as by a plunger-type electromagnet, it is possible to provide a thin and compact safety switch.

A configuration can also be such that the link member functions as the transmission section, the working member engages with a part of the link member, the displacement of the working member is transmitted to the lock member and the lock mechanism side switching contacts via the link member. (Claim 5). With such a configuration, since the electromagnetic force of attraction generated by energizing the hinge-type electromagnet is transmitted to the lock member and the lock mechanism side switching contacts via the link member engaged with the working member, it is possible to reliably open/close the lock mechanism side switching contacts using a fewer components.

Furthermore, a configuration can also be such that the switch main unit has a rectangular parallelepiped shape, and an actuator entry opening is formed at one of a pair of opposing corner portions of the switch main unit, and a cable extraction opening is formed at the other, and a cable is extracted from the cable extraction opening substantially in a direction of joining the pair of opposing corner portions. (Claim 6). With such a configuration, the relationship between the actuator entry opening and the cable extraction opening realizes a high degree of freedom in terms of a cable extraction direction, and therefore the safety switch can be provided on a wall surface or on a protective door, and furthermore, the actuator entry opening can be arranged so as to be horizontal or vertical. Furthermore, either a front or rear surface of the safety switch can be attached to the mounting location. Accordingly, a degree of freedom with regard to mounting of the safety switch is increased, and a wider range of safety switch mounts is available.

Furthermore, a configuration is possible in which the switch section side switching contacts are connected electrically within the switch main unit to an end portion of an external connection cable, and an entry and withdrawal conditions of the actuator are detected based on an electrical signal resulting from opening and closing of the contacts of the switch section side switching contacts. As a result of such a configuration, entry and withdrawal of the actuator can be detected from the exterior based on an electrical signal resulting from opening and closing of the contacts of the switch section side switching contacts.

Furthermore, a configuration can also be such that at least the lock member of the lock mechanism is provided as a unit and arranged so as to be capable of being freely built into and removed from the drive section. With such a configuration, since the lock member is provided as a unit and arranged so as to be capable of being freely built into and removed from the drive section, even in a situation in which the lock member breaks, it is sufficient to replace this unit in order to restore the safety switch efficiently and in a short period of time.

### EFFECTS OF THE INVENTION

As described above, according to the aspect of claim 1 of the present invention, since the link member directly switches the open-close conditions of the lock mechanism side switching contacts provided in the lock mechanism pursuant to the motion of the lock member, the open-close conditions of the lock mechanism side switching contacts can be reliably switched in a coupled manner with the motion of the lock member between the lock position and the unlock position. Therefore, since the link member reliably switches the open-close conditions of the lock mechanism side switching contacts provided in the lock mechanism in a manner coupled with the motion of the lock member between the lock position and the unlock position, for example, by monitoring the open-close conditions of the lock mechanism side switching contacts provided in the lock mechanism, it is possible to determine to which of the lock position and the unlock position the lock member has moved, that is, which of the locked state and the unlocked state the rotation of the drive cum is in.

According to the aspect of claim 2 of the present invention, the lock member is directly connected to the respective movable contacts of the two or more lock mechanism side switching contacts via the link member. Therefore, when the link member moves pursuant to the motion of the lock member, the movable contacts of the lock mechanism side switching contacts reliably move pursuant to the motion of the link member. As a result, the open-close conditions of these lock mechanism side switching contacts can be reliably and simultaneously switched in a manner coupled with the motion of the lock member between the lock position and the unlock position.

According to the aspect of claim 3 of the present invention, by connecting the lock member, the link member and the respective movable contacts of the normally-open and normally-closed switching contacts, the open-close conditions of the normally-open and normally-closed switching contacts can be reliably and simultaneously switched in a manner coupled with the motion of the lock member. In addition, for example, when fusion occurs to the contact of one of the normally-open and normally-closed switching contacts so that the movable contact thereof cannot move normally, the link member connected to the fused movable contact cannot move either. Accordingly, the movable contact of the other normal switching contact connected in a similar manner to the link member does not move either, and the normally-open and normally-closed switching contacts reliably maintain the opposite open-close conditions.

According to the aspect of claim 4 of the present invention, the drive section transmits to the lock member via the transmission section the displacement of the working member caused by the electromagnetic force of attraction generated by energizing the hinge-type electromagnet so as to move the lock member. Therefore, in comparison to usage of the electromagnetic force of attraction in a straight-line fashion such as by a plunger-type electromagnet, it is possible to provide a thin and compact safety switch.

According to the aspect of claim 5 of the present invention, since the electromagnetic force of attraction generated by energizing the hinge-type electromagnet is transmitted to the lock member and the lock mechanism side switching contacts via the link member engaged with the working member, it is possible to reliably open/close the lock mechanism side switching contacts using a fewer components.

According to the aspect of claim 6 of the present invention, the relationship between the actuator entry opening and the cable extraction opening makes it possible for the safety switch to be provided on a wall surface or on a protective door, and in addition, the actuator entry opening can be arranged so as to be horizontal or vertical. Furthermore, either a front or rear surface of the safety switch can be attached to the mounting location. Accordingly, a degree of freedom with regard to mounting of the safety switch is increased, and a wider range of safety switch mounts is available.

### BRIEF DESCRIPTION OF DRAWINGS

FIG. 1 is a cross-sectional view of a switch main unit according to a first embodiment of the present invention.

FIG. 2 is a cross-sectional view of the switch main unit according to the first embodiment of the present invention.

FIG. 3 is a cross-sectional view of the switch main unit according to the first embodiment of the present invention.

FIG. 4 is a cross-sectional view of the switch main unit according to the first embodiment of the present invention.

FIGS. 5A1 to 5B2 are a cross-sectional view of a lock switching contact section according to the first embodiment of the present invention.

FIGS. 6A and 6B are an external view of a safety switch according to the first embodiment of the present invention.

FIG. 7 is a view illustrating a lock member unit according to a second embodiment of the present invention.

FIGS. 8A to 8D are a cross-sectional view of a lock switching contact section according to a third embodiment of the present invention.

FIGS. 9A to 9D are a cross-sectional view of a lock switching contact section according to a fourth embodiment of the present invention.

FIGS. 10A to 10D are a cross-sectional view of a lock switching contact section according to another embodiment of the present invention.

FIGS. 11A to 11D are a cross-sectional view of a lock switching contact section according to another embodiment of the present invention.

FIGS. 12A and 12B are a view illustrating a lock member according to another embodiment of the present invention.

FIG. 13 is a cross-sectional view illustrating a solenoid unit of a conventional safety switch.

### DESCRIPTION OF REFERENCE NUMERALS

1: Switch main unit
3: Actuator
33a: Cable extraction opening
5: Operation section
15: Drive cam
15a: Engaging section
15b: Notch cut-out section
15c: Cam curve section
21: Operating rod
39, 40: Normally-closed switching contacts (switch section side switching contacts)
7: Switch section
8: Lock mechanism section
8a: Lock mechanism
80, 802d, 803, 804: Lock members
802: Lock member unit
80a, 802f, 803a, 804a: Tip sections
80b, 802e, 803b, 804b: Bases
81: Drive section
81a: Hinge-type electromagnet
81b: Working member
81d: Link member (transmission section)
85, 185, 285; 385, 485: Normally-open switching contacts (lock mechanism side switching contacts)
86, 186, 286, 386, 486: Normally-closed switching contacts (lock mechanism side switching contacts)
85a, 86a: Movable contacts
9a: Actuator entry opening

### BEST MODE FOR CARRYING OUT THE INVENTION

### First Embodiment

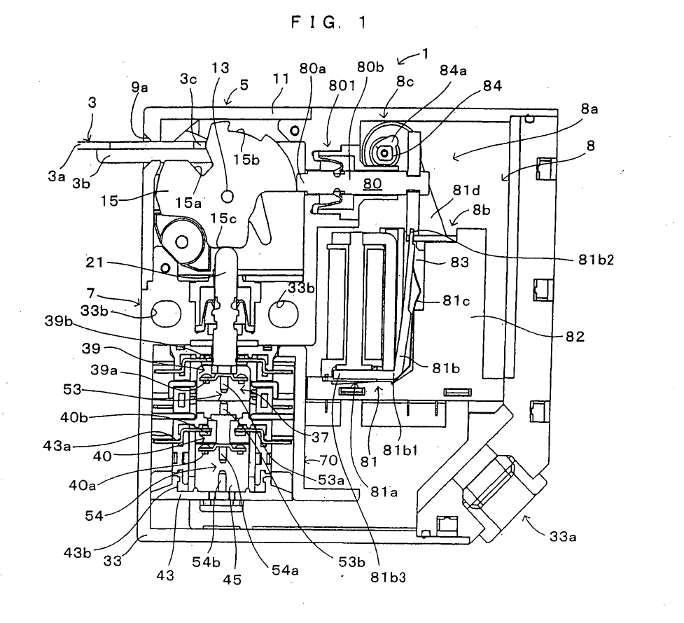

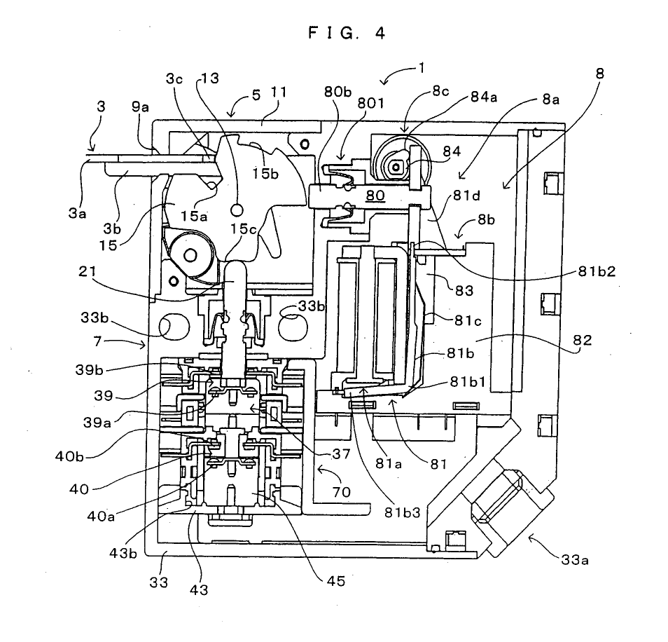

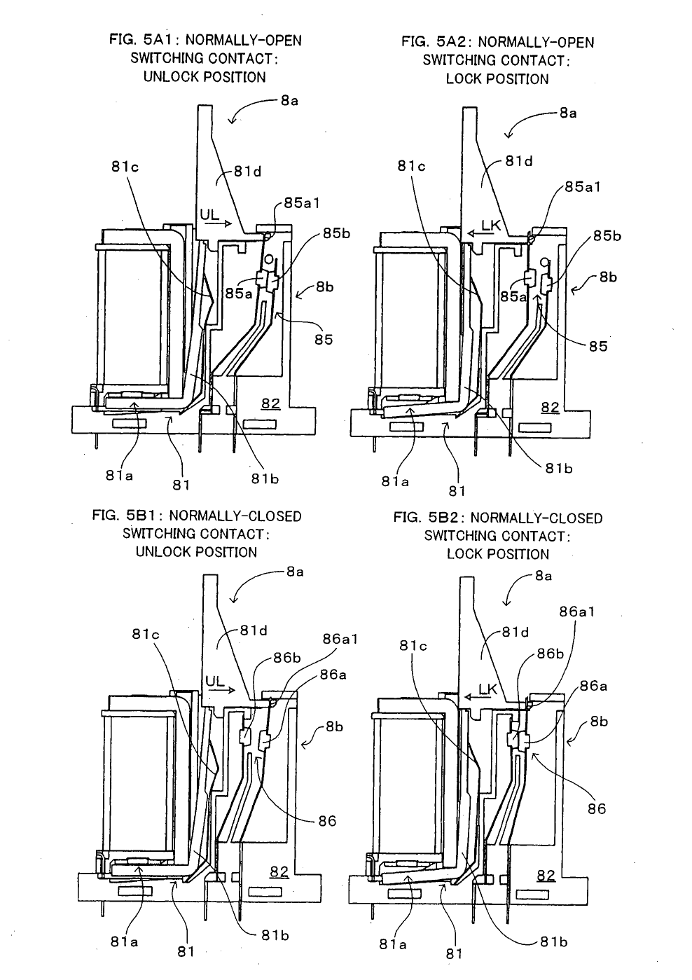

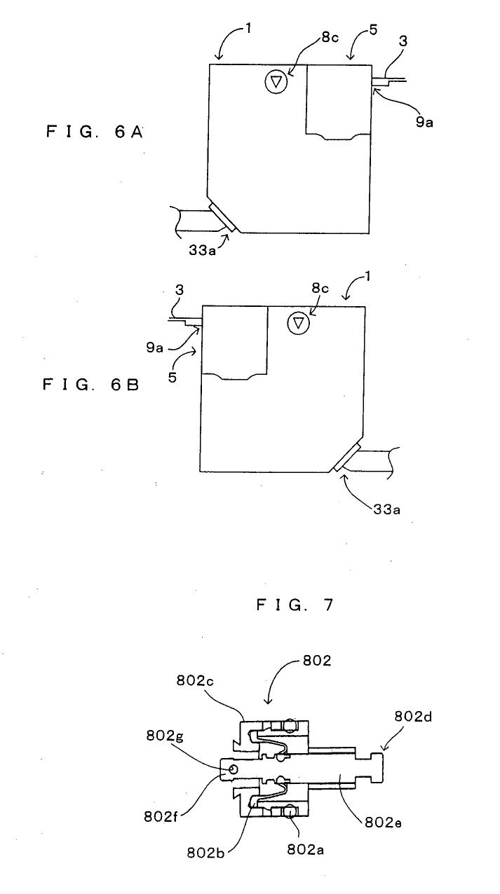

The following is a description of a first embodiment of the present invention with reference to drawings FIGS. 1 to 6B. FIGS. 1 to 4 illustrate cross-sectional views of a switch main unit, and FIGS. 5A1 to 5B2 illustrate a cross-sectional view of a lock switching contact section, and FIGS. 6A and 6B illustrate an exterior view of a safety switch.

A safety switch according to the present invention is, in almost the same way as the above-explained conventional item, a switch connected electrically via a cable to an external device in the form of industrial machinery such as a robot etc., and as shown in FIG. 1, includes a switch main unit 1 and an actuator 3.

At this time, the switch main unit 1 includes an operation section 5, a switch section 7, and a lock mechanism section 8, and is fixed to a peripheral wall surface of a protective door of industrial machinery, omitted from the drawings. Furthermore, the actuator 3 is fixed to the protective door at a position opposing an actuator entry opening 9a formed in a side face of the operation section 5, and when the protective door is closed, the actuator 3 enters the actuator entry opening 9a of the operation section 5. It should be noted that the actuator 3 includes, as shown in FIG. 1, a base 3a, a pair of pressing pieces 3b protruding from the base 3a, and a connecting piece 3c mutually connecting these pressing pieces 3b. At this time, in contrast to a planar pressing piece of an actuator having a large width and small thickness, both pressing pieces 3b have a small width and large thickness, and a cross-section wherethrough the connecting piece 3c passes forms a sideway U-shape.

The operation section 5 disposed at a top-left portion of the switch main unit 1 includes, as shown in FIGS. 1 to 4, a case member 11 and a drive cam 15 having a rotating shaft 13 pivotably supported on an inner surface of this case member 11 and supported so as to be capable of freely rotating. At an upper portion of an outer peripheral surface of this drive cam 15, an engaging section 15a wherein the connecting piece 3c of the actuator 3 is fit by insertion is formed at a position that can be seen via the above-explained actuator entry opening 9a. In addition, a notch cut-out section 15b engaging with a lock member 80 of a lock mechanism section 8 explained hereinafter is formed at an upper portion of the outer peripheral surface of this drive cam 15. Furthermore, a cam curve section 15c is formed at a bottom portion of the outer peripheral surface of the drive cam 15, and a semispherical tip of an operating rod 21 having a tip portion protruding so as to be capable of freely entering and withdrawing with respect to the operation section 5 from the switch section 7 disposed below the operation section 5 slide-contacts with the cam curve section 15c of the drive cam 15. Also, when the operating rod 21 reciprocates entry and withdrawal movement pursuant to rotation of the drive cam 15, an open-close condition of a switching contact of a switching contact section 70 integrated into the switch section 7 is switched.

Next, the switch section 7 is explained. This switch section 7 includes, as shown in FIG. 1, the switching contact section 70 disposed inside a case member 33 that forms a switch main unit 1 of a rectangular parallelepiped shape integrated with the case member 11 and below the operation section 5, in which switch section side switching contacts are integrated, and the above-explained operating rod 21. Furthermore, it is configured such that a side of the case member 11 towards the operation section 5 can be mounted on this case member 33 so as to be freely attachable and detachable. In addition, a cable extraction opening 33a of a cable for external connection is formed in a corner portion at a side towards the case member 33 opposing a corner portion at a side towards the case member 11 wherein the actuator entry opening 9a is formed. Furthermore, as shown in FIG. 1, a pair of mounting holes 33b wherein bolts for mounting the switch main unit 1 onto a peripheral wall surface of a protective door of industrial machinery are inserted is formed in the outer surface of the case member 33.

It should be noted that a movable member 37 contacting another end portion of the operating rod 21 and capable of moving integrally with the operating rod 21, and first and second normally-closed switching contacts 39, and 40 opening and closing in a coupled manner with this movable member 37 are provided in the switching contact section 70. The normally-closed switching contacts 39 and 40 include movable contacts 39a and 40a, and fixed contacts 39b and 40b, respectively, each of the movable contacts 39a and 40a is fixed to the movable member 37, and each of the fixed contacts 39b and 40b is fixed to a frame member 43 provided in the switching contact section 70. Here, one of the normally-closed switching contacts 39 and 40, for example, the normally-closed switching contact 39, is for providing and cutting off a supply of power to the industrial machinery and is connected in series with a normally-closed switching contact 86 provided in the lock mechanism section 8 explained hereinafter. Furthermore, the normally-closed switching contact 40 is for monitoring the open-close conditions of these switching contacts for providing and cutting off a supply of power.

Also, the movable member 37 includes a planar base section 45 and a first mounting section 53 and a second mounting section 54 arranged vertically at both ends of one face of this base section 45 (the surface side of FIG. 1). One end side thereof is in contact with the other end of the operating rod 21 and a coil spring (not shown) is mounted on that other end side thereof; and the movable member 37 is urged in a direction of the operation section 5, that is, in an upward direction, by the coil spring. Furthermore, a pair of protrusions 53a and 53b and a pair of protrusions 54a and 54b are provided on the mounting sections 53 and 54, respectively, so as to be mutually opposed in a longitudinal direction of the movable member 37.

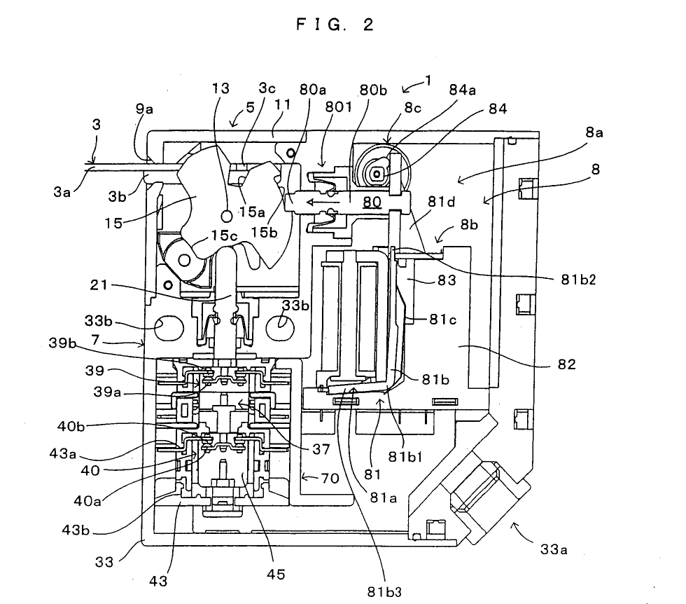

Also, the movable contacts 39a and 40a of the first and second normally-closed switching contacts 39 and 40 are each mounted so as to be freely attachable and detachable on a foot portion of one of each pair of the protrusions, namely, the protrusions 53a and 54a. The movable contacts 39a and 40a are fixed in a pressed manner on the mounting sections 53 and 54 respectively, by a spring (not shown) externally fitted on each of the protrusions 53a, 53b, 54a, 54b, and through an action of these springs, as shown in FIG. 2 in particular, a contact force is produced between the movable contacts 39a and 40a and the fixed contacts 39b and 40b, respectively.

Here, a cable (not shown) connected electrically to the industrial machinery is attached to the case member 33, and the cable and each of the normally-closed switching contacts 39 and 40 are connected electrically within the switching contact section 70. Detection of entry and withdrawal of the actuator 3 with respect to the operation section 5, and provision and cutting off of a supply of power to the industrial machinery can be carried out using an electrical signal resulting from opening and closing of each of the normally-closed switching contacts 39 and 40.

It should be noted that the fixed contact 40b of the second normally-closed switching contact 40 is, as shown in FIG. 1, mounted so as to be freely attachable and detachable on a normally-closed switching contact mounting section 43a formed in the frame member 43 of the switching contact section 70, is mounted such that the mounting position and mounting condition thereof can be changed together with those of the movable contact 40a, and therefore the second normally-closed switching contact 40 can be switched to a normally-open switching contact.

That is to say, in addition to the above-explained normally-closed switching contact mounting section 43a, a normally-open switching contact mounting section 43b on which the fixed contact 40b can mounted so as to be freely attachable and detachable is formed on the frame member 43, and the second normally-closed switching contact 40 can be switched to a normally-open switching contact by removing the moveable terminal 40a of the second normally-closed switching contact 40 from one of the protrusions 54a and mounting on the side of the other protrusion 54b, and removing the fixed contact 40b from the normally-closed switching contact mounting section 43a and mounting on the normally-open switching contact mounting section 43b. In this way, as this normally-open switching contact performs an opposite open-close operation to that of the first normally-closed switching contact 39, it can be used as a switching contact for monitoring of a different operation to that in the case of the second normally-closed switching contact 40, and the configuration as the normally-open or normally-closed switching contact can be selected in accordance with intended use.

It should be noted that, in a condition of FIG. 1 wherein the actuator 3 has not entered, the operating rod 21 is pushed by the cam curve section 15c of the drive cam 15 against the coil spring and is in a condition wherein the most part thereof is sunken towards the side of the switch section 7, and the movable member 37 is being pressed upon by the operating rod 21. As a result of this, the movable contacts 39a and 40a and the fixed contacts 39b and 40b of each of the normally-closed switching contacts 39 and 40 separate, each of the normally-closed switching contacts 39 and 40 is in an open condition, a supply of power to the industrial machinery is cutoff, and the industrial machinery is in an inoperable condition.

Next, the lock mechanism section 8 is explained. The lock mechanism section 8 is, as shown FIG. 1, disposed inside the case member 33 and rightward of the operation section 5, and includes a lock mechanism 8a and a manual lock release mechanism 8c. It should be noted that the lock mechanism 8a includes the lock member 80 described above, a drive section 81 for moving the lock member 80, and normally-open and normally-closed switching contacts 85 and 86 that correspond to “lock mechanism side switching contact” of the present invention, a link member 81d for switching the open-close conditions of the normally-open and normally-closed switching contacts 85 and 86 in a coupled manner with the motion of the lock member 80. Also, the normally-open and normally-closed switching contacts 85 and 86 are arranged aligned in the lock switching contact section 8b in the front and back sides as viewed from a direction vertical to the sheet surface in FIG. 1, that is, in the front and rear sides.

The lock member 80 constituting a part of the lock mechanism 8a is supported by a lock member support section 801 so as to be capable of freely moving between an unlock position shown in FIG. 1 and a lock position shown in FIG. 2 in a direction substantially perpendicular to the rotating shaft 13 of the drive cam 15. Furthermore, an outer diameter of a tip section 80a of the lock member 80 is structured so as to be smaller than an outer diameter of a base 80b. Also, when the lock member 80 moves to the lock position, a rotation of the drive cam 15 is locked as a result of the tip section 80a engaging with the notch cut-out section 15b of the drive cam 15. Meanwhile, when the lock member 80 moves to the unlock position, the engagement between the tip section 80a and the notch cut-out section 15b is released and the drive cam 15 becomes capable of rotation.

Furthermore, the drive section 81 includes a hinge-type electromagnet 81a formed by wrapping a coil on a core in which a working member 81b formed in an approximate L-shape from magnetic material such as iron, etc. is displaced when acted upon by an electromagnetic force of attraction resulting from energization of the hinge-type electromagnet 81a; a return spring 81c formed from a leaf spring and urging the working member 81b leftward; and the link member 81d transmitting displacement of the working member 81b to the lock member 80. The hinge-type electromagnet 81a is arranged such that a direction of a central axis thereof is substantially perpendicular to a motion direction of the lock member 80, and is supported by a case 82 of the lock switching contact section 8b. Furthermore, as shown in FIG. 1, the hinge-type electromagnet 81a is supported by the case 82 so as to produce a gap 83 between the hinge-type electromagnet 81a and the case 82, and the working member 81b and the return spring 81c are provided in the gap 83.

The working member 81b is a member formed in an approximate L-shape such that a bend section 81b1 thereof has an obtuse angle, and is provided within the gap 83 so as to be capable of freely swinging with the bend section 81b1 portion as a central axis of swinging. Furthermore, the return spring 81c is disposed rightward of the working member 81b within the gap 83 such that the urging force thereof works in a leftward direction. Furthermore, the link member 81d is connected to (engaged with) an upper end section 81b2 of the working member 81b, and the lock member 80 is pivotally supported by the link member 81d.

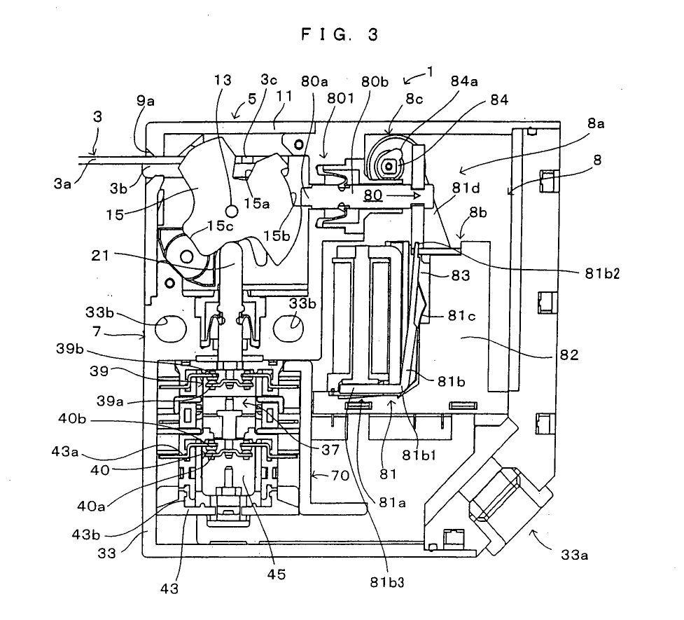

Accordingly, as shown in FIG. 2, if energization of the hinge-type electromagnet 81a is shutoff, the working member 81b is urged leftward by the return spring 81c and the upper end section 81b2 moves leftward with the bend section 81b1 portion as a central axis of swinging. Also, pursuant to the leftward motion of the upper end section 81b2, the link member 81d connected to the upper end section 81b2 moves leftward, and the lock member 80 pivotally supported by the link member 81d moves in an arrow direction of FIG. 2, or in other words, towards the lock position. The link member 81d may be moved leftward using only the urging force of a terminal plate as a plate spring including movable contacts 85a and 86a described later. Meanwhile, if the hinge-type electromagnet 81a is energized, a bottom-left end section 81b3 of the working member 81b is drawn to the hinge-type electromagnet 81a by the electromagnetic force of attraction of the hinge-type electromagnet 81a. As a result, the upper end section 81b2 of the working member 81b moves rightward against the urging force of the return spring 81c with the bend section 81b1 as a central axis of swinging. Also, pursuant to the rightward motion of the upper end section 81b2, the link member 81d connected to the upper end section 81b2 moves rightward, and the lock member 80 pivotally supported by the link member 81d moves in an arrow direction of FIG. 3, or in other words, towards the unlock position. In this manner, in the present embodiment, the link member 81d functions as a “transmission section” of the present invention.

Additionally, as shown in FIG. 5, the normally-open switching contact 85 and the normally-closed switching contact 86 are provided aligned at the front side and the back side of the case 82 of the lock switching contact section 8b, respectively. These normally-open and normally-closed switching contacts 85 and 86 include the movable contacts 85a and 86b, and the fixed contacts 85b and 86b, respectively. The lower end portion of the terminal plate that includes these contacts is supported by the case 82 so that these contacts are arranged in the case 82. In the normally-open switching contact 85, the movable contact 85a is arranged to the left of the fixed contact 85b, and in the normally-closed switching contact 86, the movable contact 86a is arranged to the right of the fixed contact 86b. Upper end sections 85a1 and 86a1 of the terminal plate on the side toward the movable contacts 85a and 86a are respectively engaged with the above-described link member 81d. Therefore, these movable contacts 85a and 86a simultaneously move in the same direction in a coupled manner with the motion of the link member 81d. Also, in the present embodiment, the link member 81d is provided connecting the above-described lock member 80 to the movable contacts 85a and 86a. Consequently, when the link member 81d moved in the direction of the arrow LK and the lock member 80 has moved to the lock position (see FIG. 2), the normally-open and normally-closed switching contacts 85 and 86 simultaneously become an open and a closed conditions, respectively (see FIGS. 5A2 and 5B2). When the link member 81d moved in the direction of the arrow UL and the lock member has moved to the unlock position (see FIGS. 1 and 3), the normally-open and normally-closed switching contacts 85 and 86 simultaneously become a closed and an open conditions, respectively.

Also, in the present embodiment, the link member 81d that engages with the upper end section 81b2 of the working member 81b connects the lock member 80 and the movable contacts 85a and 86a, and therefore, displacement of the upper end section 81b2 of the working member 81b caused by the electromagnetic force of attraction of the hinge-type electromagnet 81a is simultaneously transmitted to the lock member 80 and the movable contacts 85a and 86a via the link member 81d, and they simultaneously move. And as explained above, for example, the normally-closed switching contact 86 within the case 82 is connected in series with the first normally-closed switching contact 39 connected to the industrial machinery of the switching contacts provided in the switching contact section 70. Furthermore, an operation of the lock member 80 can be detected by monitoring an electrical signal of the normally-open switching contact 85.

In addition, the manual lock release mechanism 8c is provided with a release cam 84 having a projection 84a. As shown in FIG. 2, when the lock member 80 moves to the lock position and the lock member 80 becomes engaged with the notch cut-out section 15b, the locked state can be released by rotating the release cam 84 clockwise from the exterior of the switch main unit 1 using, for example, a release key. That is to say, by rotating the release cam 84 clockwise, the link member 81d can be moved rightward while the projection 84a making sliding contact with the link member 81d. As a result, pursuant to the rightward motion of the link member 81d, the lock member 80 pivotally supported by the link member 81d also moves rightward in a coupled manner, the engagement condition between the lock member 80 and the notch cut-out section 15b is released, and the drive cam 15 can be made capable of rotating.

Next, an operation is explained. As shown in FIG. 1, when the actuator 3 has not entered the operation section 5 of the switch main unit 1, the operating rod 21 is pushed by a large diameter portion of the cam curve section 15c of the drive cam 15 against the coil spring and is in a condition wherein the most part thereof is sunken towards the side of the switch section 7, and the movable member 37 is being pressed upon by the operating rod 21. As a result of this, the movable contacts 39a and 40a and the fixed contacts 39b and 40b of the normally-closed switching contacts 39 and 40 separate, and each of the normally-closed switching contacts 39 and 40 is in an open condition. Accordingly, a supply of power to the industrial machinery is cutoff, and the industrial machinery is in an inoperable condition. Furthermore, the lock member 80 is pushed against the return spring 81c by an outer periphery portion of the drive cam 15 and has moved to the unlock position, and the normally-open and normally-closed switching contacts 85 and 86 of the lock switching contact section 8b are closed and open, respectively, as shown in FIGS. 5A1 and 5B1.

Next, when the actuator 3 enters the operation section 5 as a result of closure of a protective door, etc., as shown in FIG. 2, the connecting piece 3c of the actuator 3 engages with the engaging section 15a of the drive cam 15, and pursuant to entry of the actuator 3, the drive cam 15 is rotated clockwise. Pursuant to the rotation of drive cam 15, the operating rod 21 moves upward as a result of the urging force of the coil spring while a tip thereof making sliding contact from a large diameter portion to a small diameter portion of the cam curve section 15c. Pursuant to the upward motion of the operating rod 21, the normally-closed switching contacts 39 and 40 change from an open condition to a closed condition. Furthermore, the notch cut-out section 15b moves to a position opposing the lock member 80 pursuant to the rotation of the drive cam 15, and consequently, the lock member 80 moves leftward as a result of the urging force of the return spring 81c, the notch cut-out section 15b and the tip section 80a of the lock member 80 become engaged, rotation of the drive cam 15 is locked, and extraction of the actuator 3 is prevented. By the lock member 80 moving to the lock position, as shown in FIGS. 5A2 and 5B2, the normally-open and normally-closed switching contacts 85 and 86 of the lock switching contact section 8b are switched respectively to an open and a closed condition. Accordingly, the normally-closed switching contact 86 of the lock switching contact section 8b and the first normally-closed switching contact 39 are simultaneously in a closed condition, and therefore, a supply of power is provided to industrial machinery such as robots connected in series with these normally-closed switching contacts, and the industrial machinery can operate.

Next, when the hinge-type electromagnet 81a is energized as a result of external control, as shown in FIG. 3, the bottom-left end section 81b3 of the working member 81b is drawn towards the hinge-type electromagnet 81a by the electromagnetic force of attraction of the hinge-type electromagnet 81a. Consequently, the upper end section 81b2 of the working member 81b moves rightward against the urging force of the return spring 81c with the bend section 81b1 as a central axis of swinging, and as a result, the lock member 80 moves to the rightward unlock position pursuant to the rightward motion of the link member 81d. Accordingly, the engagement condition between the lock member 80 and the notch cut-out section 15b is released, and the locked state of the rotation of the drive cam 15 is released, the actuator 3 becomes capable of withdrawal, and the protective door, etc. can be opened. Pursuant to the motion of the lock member 80 to the unlock position, as shown in FIGS. 5A1 and 5B1, the normally-open and normally-closed switching contacts 85 and 86 of the lock switching contact section 8b are switched respectively to a closed and an open condition. As a result, a supply of power to industrial machinery connected in series with the normally-closed switching contact 86 of the lock switching contact section 8b and the first normally-closed switching contact 39 is cutoff, and the industrial machinery becomes inoperable. Also, this unlocked state can be detected by an electrical signal passing through the normally-open switching contact 85 of the lock switching contact section 8b.

The following is a detailed description of a situation wherein an attempt is made to forcibly withdraw and extract the actuator 3 from the operation section 5 with, as shown in FIG. 2, the rotation of the drive cam 15 in a locked state, with reference to FIGS. 2 and 4. As the connecting piece 3c of the actuator 3 is engaged with the engaging section 15a of the drive cam 15, when the actuator 3 is forcibly withdrawn, a forcible rotation force is applied to the drive cam 15. At this time, the tip section 80a of the lock member 80 remains engaged with the notch cut-out section 15b of the drive cam 15, and therefore, a force of extraction of the actuator 3 is concentrated in a portion of engagement of the tip section 80a, engaged with the drive cam 15, and the notch cut-out section 15b. Also, if the actuator 3 is forcibly extracted from the switch main unit 1, as the diameter of the tip section 80a is set small so as to set the fracture strength of the tip section 80a lower than the fracture strength of the notch cut-out section 15b, the tip section 80a of the lock member 80 of lower fracture strength breaks before the notch cut-out section 15b of the drive cam 15, and the drive cam 15 becomes capable of rotation.

Then, pursuant to withdrawal of the actuator 3 from the operation section 5, the drive cam 15 is rotated in a counter-clockwise direction and the connecting piece 3c of the actuator 3 comes free of the engagement condition with the engaging section 15a. At this time, as shown in FIG. 4, as the cam curve section 15c of the drive cam 15 and the operating rod 21 are in a normal condition and free of breakage, pursuant to the counter-clockwise rotation of the drive cam 15, the operating rod 21 moves downward against the urging force of the coil spring while making sliding contact from a small diameter portion to a large diameter portion of the cam curve section 15c. Also, pursuant to the downward motion of the operating rod 21, the normally-closed switching contacts 39 and 40 of the switching contact section 70 adopt an open condition normally. That is to say, the normally-closed switching contacts 39 and 40 provided in the switching contact section 70 are operating normally, and therefore, based on the condition of these normally-closed switching contacts 39 and 40, extraction (withdrawal) of the actuator 3 is detected and a supply of power to the industrial machinery is surely and reliably cutoff.

As described above, in the present embodiment, the link member 81d directly and simultaneously switches the open-close conditions of the normally-open and normally-closed switching contacts 85 and 86 pursuant to the motion of the lock member 80. Therefore, the open-close conditions of the normally-open and normally-closed switching contacts 85 and 86 can be reliably switched in a manner coupled with the motion of the lock member 80 between the lock position and the unlock position. As a result, the link member 81d reliably switches the open-close conditions of the normally-open and normally-closed switching contacts 85 and 86 provided in the lock switching contact section 8b in a manner coupled with the motion of the lock member 80 between the lock position and the unlock position. Therefore, for example, by monitoring the open-close conditions of the normally-open and normally-closed switching contacts 85 and 86, it is possible to determine to which of the lock position and the unlock position the lock member 80 has moved, that is, which of the locked state and the unlocked state the rotation of the drive cum 15 is in.

Also in the present embodiment, the movable contacts 85a and 86a of the normally-open and normally-closed switching contacts 85 and 86 are connected to the lock member 80 via the link member 81d. Therefore, the open-close conditions of the normally-open and normally-closed switching contacts 85 and 86 can be reliably and simultaneously switched as a result of the movable contacts 85a and 86a moving simultaneously via the link member 81d, in a coupled manner with the motion of the lock member 80. In addition, for example if fusion occurs to the contact of one of the normally-open and normally-closed switching contacts 85 and 86, and makes it impossible for the fused movable contact to normally move, the link member 81d connected to the fused movable contact cannot move either. For this reason, the movable contact of the other normal switching contact similarly connected to the link member 81 does not move either. Accordingly, when one of the switching contacts is subject to a problem, the other switching contact can be prevented from operating normally, and therefore, it is possible for the normally-open and normally-closed switching contacts 85 and 86 to reliably keep the opposite open-close conditions.

Furthermore, in this embodiment, the hinge-type electromagnet 81a is arranged such that a direction of the core (central axis) thereof is substantially perpendicular to a motion direction of the lock member 80 between the lock position and the unlock position, and the lock member 80 is moved by transmitting the electromagnetic force of attraction generated by energizing the hinge-type electromagnet 81a to the lock member 80 with the direction of working thereof deflected via the working member 81b and the link member 81d. Therefore, in comparison, for example, to usage of the electromagnetic force of attraction in a straight-line fashion such as by a plunger-type electromagnet, it is possible to realize a thinner, and more compact entire safety switch. It should be noted that it is possible to engage the working member 81b with the lock member 80 so as to transmit the displacement of the working member 81b to the link member 81b and the movable contacts 85a and 86a via the lock member 80. In this case, the working member 81d functions as the “transmission section” of the present invention.

In the present embodiment, the link member 81d is engaged with the working member 81b, and the displacement of the working member 81b is transmitted to the lock member 80 and the movable contacts 85a and 86a via the link member 81b. Therefore, the electromagnetic force of attraction generated by energizing the hinge-type electromagnet 81 is transmitted to the lock member 80 and the lock mechanism side switching contacts the via the link member 81d engaged with the working member 81b, which makes it possible to reliably open and close the lock mechanism side switching contacts with a fewer components.

Furthermore, in this embodiment, the switch main unit 1 has a rectangular parallelepiped shape, and the actuator entry opening 9a is formed at one of a pair of opposing corner portions of the switch main unit 1 and the cable extraction opening 33a is formed at the other corner portion. For this reason, as shown in FIGS. 6A and 6B, the relationship between the actuator entry opening 9a and the cable extraction opening 33a realizes a high degree of freedom in terms of a cable extraction direction, and the safety switch can be provided on a wall surface or on a protective door; furthermore, the actuator entry opening can be arranged so as to be horizontal or vertical. Furthermore, either a front or rear surface of the safety switch can be attached to the mounting location. Accordingly, a degree of freedom with regard to mounting of the safety switch is increased, and a wider range of safety switch mounts is available. Furthermore, as such a configuration increases the degree of freedom with regard to safety switch mounting, it is acceptable to not provide two actuator entry openings as in the conventional technology, and therefore, it is possible to prevent breakage of the safety switch as a result of the entry of dust, etc. from the actuator entry opening on the unused side, and to also improve the durability of the safety switch. It should be noted that FIG. 6A is a view with a front surface of a safety switch on a top side, and FIG. 6B is a view with a back surface of a safety switch on a top side.

Also, in this embodiment, even when the lock member 80, which has lower fracture strength, breaks as a result of forcibly withdrawing and extracting the actuator 3 from the operation section 5 with rotation of the drive cam 15 locked, and consequently the drive cam 15 becomes capable of rotation, the cam curve section 15c of the drive cam 15 and the operating rod 21 are in a normal condition and free of breakage. Therefore, when the drive cam 15 is rotated in a counter-clockwise direction pursuant to withdrawal of the actuator 3 from the operation section 5 and the connecting piece 3c of the actuator 3 comes free of the engagement condition with the engaging section 15a, the operating rod 21 moves downward while making sliding contact from a small diameter portion to a large diameter portion of the cam curve section 15c. Also, since the normally-closed switching contacts 39 and 40 of the switching contact section 70 switch normally to an open condition pursuant to this downward motion of the operating rod 21, extraction (withdrawal) of the actuator 3 can be detected based on this condition of the normally-closed switching contacts 39 and 40. Accordingly, even in a situation wherein a protective door, etc. is forcibly opened without the lock being released normally and the actuator 3 is extracted from the switch main unit 1, withdrawal of the actuator 3 from the switch main unit 1 can be detected in a sure and reliable manner.

Furthermore, in this embodiment, as the fracture strength of the tip section 80a of the lock member 80 is set lower than the fracture strength of the notch cut-out section 15b of the drive cam 15, the tip section 80a of the lock member 80 is more liable to break than the notch cut-out section 15b of the drive cam 15. For this reason, even if the tip section 80a of the lock member 80 breaks, replacement of the broken lock member 80 alone makes it possible for the safety switch to again be used in a normal condition, and therefore, a cost reduction can be realized.

Furthermore, in this embodiment, as detection of a condition of entry and withdrawal of the actuator 3 with respect to the operation section 5 is carried out using an electrical signal resulting from opening and closing of the normally-closed switching contacts 39 and 40 provided in the switching contact section 70, entry and withdrawal of the actuator 3 can be detected from the exterior using the electrical signal resulting from opening and closing of the normally-closed switching contacts 39 and 40.

Furthermore, in this embodiment, since the provision and cutting off of a supply of power to the industrial machinery is carried out using two normally-closed switching contacts 39 and 40 and based on an open-close operation thereof, for example, in a situation in which the movable contacts 39a and 40a and the fixed contacts 39b and 40b of the normally-closed switching contacts 39 and 40 have fused while a supply of power is provided to the industrial machinery with the normally-closed switching contacts 39 and 40 closed, the fused movable contacts 39a and 40a and fixed contacts 39b and 40b can be forcibly separated as a result of withdrawal of the actuator 3 and the movable member 37 being pressed upon by the operating rod 21. Therefore, the reliability of the safety switch can be improved.

### Second Embodiment

FIG. 7 is a view illustrating a lock member unit according to the present invention, and the following is a detailed description of a second embodiment of a safety switch according to the present invention, with reference to FIG. 7. The major point of difference between this second embodiment and the above-explained first embodiment is that a lock member of a lock mechanism is provided as a unit and arranged so as to be capable of being freely built into and removed from a drive section, and all other configurations and operations are identical to those of the first embodiment. The following is a detailed description of the second embodiment, focusing on differences with the first embodiment, with reference to FIG. 1 as well. It should be noted that, in terms of configurations and operations that are identical to those of the first embodiment, explanation is omitted.

As shown in FIG. 7, a lock member unit 802 is configured such that a lock member 802d is supported by a lock member support section 802c and seal members 802a, 802b. Also, this lock member unit 802 is provided upward of the hinge-type electromagnet 81a of the drive section so as to be capable of being freely built into and removed. Furthermore, the lock member 802d includes a base 802e and a tip section 802f connected to the base 802e, and an opening 802g is formed at the boundary between the base 802e and the tip section 802f in order to reduce fracture strength.

In this way, since the lock member 802d is provided as a unit in the form of the lock member unit 802 and arranged so as to be capable of being freely built into and removed from the drive section, even in a situation in which the lock member 802d breaks, it is sufficient to replace this lock member unit 802 in order to restore the safety switch efficiently and in a short period of time. Furthermore, as the opening 802g is provided in order to reduce the fracture strength of the tip section 802f of the lock member 802d, if the actuator 3 is forcibly extracted from the switch main unit 1, the tip section 802f of the lock member 802d is surely and reliably broken first and the notch cut-out section of the drive cam can be maintained in a normal condition. Accordingly, when the safety switch is broken as a result of forcible extraction of the actuator from the main unit of the safety switch, the safety switch can be restored to a normal condition simply by replacing the lock member unit 802.

### Third Embodiment

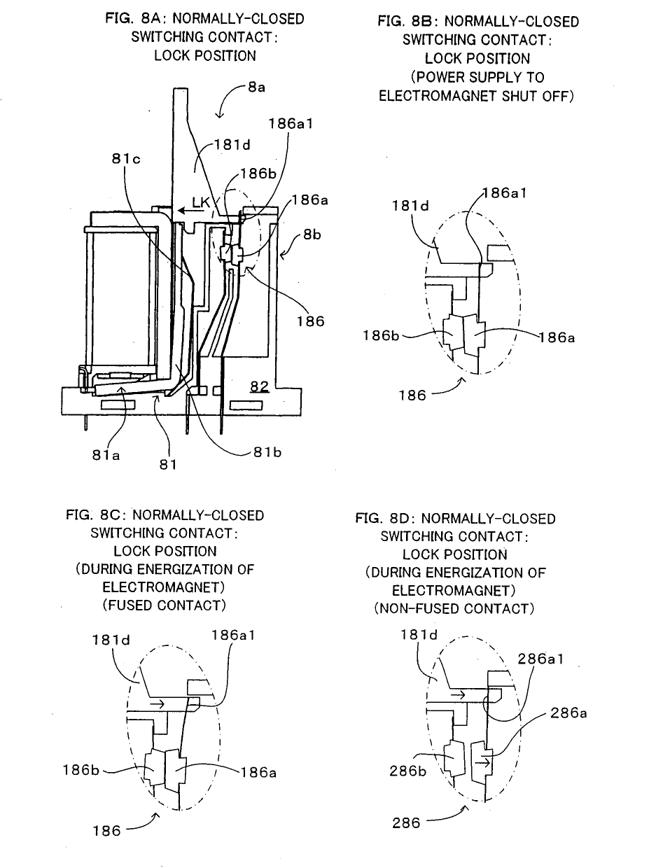

FIGS. 8A to 8D is a cross-sectional view of a lock switching contact section, and a third embodiment of the safety switch of the present invention is described in detail with reference to FIGS. 8A to 8D. The third embodiment differs from the foregoing first and second embodiments in that two normally-closed switching contacts are provided as the lock mechanism side switching contacts in the front and rear sides of the lock switching contact section 8b. The other configuration and operations are similar to those of the first embodiment. The following is a detailed description of the third embodiment, focusing on differences with the first embodiment, with reference to FIGS. 1 to 4 as well. It should be noted that, in terms of configurations and operations that are identical to those of the first embodiment, the corresponding reference numerals are assigned and explanation is omitted.

As shown in FIGS. 8A to 8D, normally-closed switching contacts 186 and 286 are provided aligned in the front side and the rear side of the case 82 of the lock switching contact section 8b, respectively. These normally-closed switching contacts 186 and 286 have movable contacts 186a and 286a, and fixed contacts 186b and 286b, respectively. The lower end portion of the terminal plate that includes these contacts is supported by the case 82 so that these contacts are arranged in the case 82. The movable contacts 186a and 286a are arranged to the right of the fixed contacts 186b and 286b, and upper end sections 186a1 and 286a1 of the terminal plate on the side toward the movable contacts 186a and 286a are respectively engaged with a link member 181d. Therefore, these movable contacts 186a and 286a simultaneously move in the same direction in a coupled manner with the motion of the link member 181d. Also, similarly to the first and second embodiments, the link member 181d is provided connecting the lock member 80 to the movable contacts 186a and 286a. Consequently, when the link member 181d moved in the direction of the arrow LK and the lock member 80 has moved to the lock position (see FIGS. 8A and 8B), the normally-closed switching contacts 186 and 286 simultaneously become a closed condition. FIGS. 8B, 8C and 8D are enlarged views of a portion enclosed with a dashed-dotted line in FIG. 8A in different conditions.

In this embodiment, the lock member 80 is directly connected to the movable contacts 186a and 286a of the normally-closed switching contacts 186 and 286 via the link member 181d. Therefore, the link member 181d moves pursuant to the motion of the lock member 80, and the movable contacts 186a and 286a of the normally-closed switching contacts 186 and 286 reliably move pursuant to the motion of the link member 181d. As a result, it is possible to reliably and simultaneously switch the open-close conditions of the normally-closed switching contacts 186 and 286 in a manner coupled with the motion of the lock member 80 between the lock position and the unlock position.

There may be a case in which fusion occurs to the contact of one of the normally-closed switching contacts. For example, the operation in a case is described in detail, in which fusion has occurred to the normally-closed switching contact 186 as shown in FIG. 8C. When the hinge-type electromagnet 81a is energized as a result of external control, as shown in FIG. 3, the bottom-left end section 81b3 of the working member 81b is drawn towards the hinge-type electromagnet 81a by the electromagnetic force of attraction of the hinge-type electromagnet 81a. Therefore, although the upper end section 81b2 of the working member 81b attempts to move rightward against the urging force of the return spring 81c with the bend section 81b1 as a central axis of swinging, the link member 181d cannot move rightward since the normally-closed switching contact 186 has fused, and consequently, the lock member 80 cannot move to the rightward unlock position. Accordingly, the engagement condition between the lock member 80 and notch cut-out section 15b is not released, and the rotation of the drive cam 15 remains locked. For this reason, the actuator 3 remains impossible to withdraw, which keeps opening the protective door, etc., impossible. In such case, there is a possibility that the operator misunderstands that the drive cum 15 is in an unlocked state while it is actually in a locked state, and forcibly opens the protective door, etc., to access the industrial machinery.

However, in this embodiment, the configuration is such that when the hinge-type electromagnet 81a is energized as a result of external control, as shown in FIG. 8C, the terminal plate on the side toward the fused movable contact 186a of the normally-closed switching contact 186 is somewhat distorted so that the link member 181d can slightly move in the direction of the arrow in FIG. 8C. As a result, as shown in FIG. 8D, the movable contact 286a of the normally-closed switching contact 286 slightly moves in the direction of the arrow in FIG. 8D, and the normally-closed switching contact 286 is switched to an open condition. Therefore, for example, as a double countermeasure for a case in which fusion has occurred to the contact of one of the normally-closed switching contacts, it is possible to reliably determine whether the hinge-type electromagnet 81a is energized as a result of external control, or any problem has occurred to the lock switching contact section 8b, by simultaneously monitoring the open-close conditions of the normally-closed switching contacts 186 and 286. Specifically, when the open-close conditions of the normally-closed switching contacts 186 and 286 are opposite, it is possible to determine that a problem has occurred to one of the normally-closed switching contacts 186 and 286.

In addition, by connecting in series the industrial machinery and the first normally-closed switching contact 39, the normally-closed switching contacts 186 and 286, when the hinge-type electromagnet 81a is energized, even if fusion has occurred to the contact of the normally-closed switching contact 186 for example, the normally-closed switching contact 286 is reliably switched to an open condition. Consequently, a supply of power to the industrial machinery is reliably cutoff so as to make the industrial machinery inoperable. Therefore, even if the operator misunderstands that the safety switch is in an unlocked state, and forcibly opens the protective door, etc., the safety of the operator can be assured since the industrial machinery is reliably made inoperable.

In this embodiment, it is naturally possible to employ the lock member unit 802 as in the foregoing second embodiment.

### Fourth Embodiment

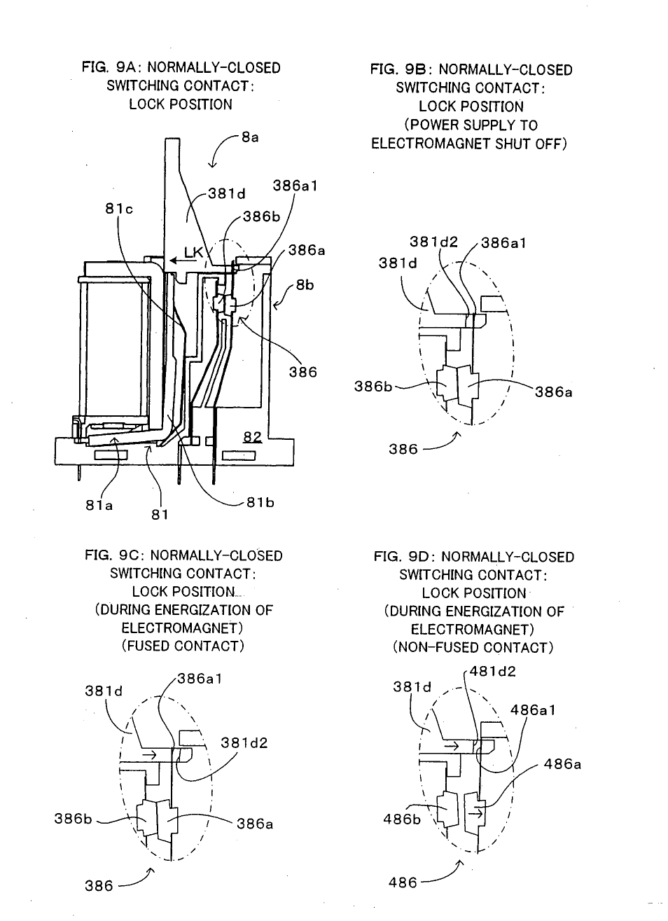

FIGS. 9A to 9D is a cross-sectional view of a lock switching contact section, and a fourth embodiment of the safety switch of the present invention is described in detail with reference to FIGS. 9A to 9D. The major difference between this fourth embodiment and the foregoing third embodiment lies in the engagement condition between the link member and the movable contacts. The other configuration and operations are similar to those of the third embodiment. The following is a detailed description of the fourth embodiment, focusing on differences with the third embodiment. It should be noted that, in terms of configurations and operations that are identical to those of the third embodiment, the corresponding reference numerals are assigned and explanation is omitted.

As shown in FIG. 9B, an opening 381d2 whose width is slightly larger than the width of the terminal plate is provided in a link member 381d. Upper end section 386a1 and 486a1 in the terminal plate on the side toward movable contacts 386a and 486a are engaged with the link member 381d by idly passing though the opening 381d2. It should be noted that FIGS. 9B, 9C and 9D are enlarged views of the portion enclosed with a dashed-dotted line in FIG. 9A in different conditions. With such a configuration, since the link member 381d engages with the movable contacts 386a and 486a by the upper end of the terminal plate on the sides toward the movable contacts 386a and 486a idly passing through the opening 381d2, when the hinge-type electromagnet 81a is energized as a result of external control, as shown in FIG. 9C, the link member 381d can move in the direction shown by the arrow in FIG. 9C although slightly, by an amount corresponding to the size of the opening 381d2 (clearance). In addition, the terminal plate including the movable contacts 386a and 486a is formed by a leaf spring with the urging force thereof acting in the direction of the arrow in FIG. 9D. Therefore as shown in FIG. 9D, the movable contact 486a of a normally-closed switching contact 486 can move in the direction of the arrow, although slightly.

As a result, the normally-closed switching contact 486 is reliably switched from a closed condition to an open condition. Accordingly, for example, as a double countermeasure for a case in which fusion has occurred to the contact of one of the normally-closed switching contacts, it is possible to reliably determine whether the hinge-type electromagnet 81a is energized as a result of external control, or any problem has occurred to the lock switching contact section 8b, by simultaneously monitoring the open-close conditions of a normally-closed switching contact 386 and the normally-closed switching contact 486. Specifically, when the open-close conditions of the normally-closed switching contacts 386 and 486 are opposite, it is possible to determine that a problem has occurred to one of the normally-closed switching contacts 386 and 486, and the effect similar to the third embodiment can be achieved.

Other

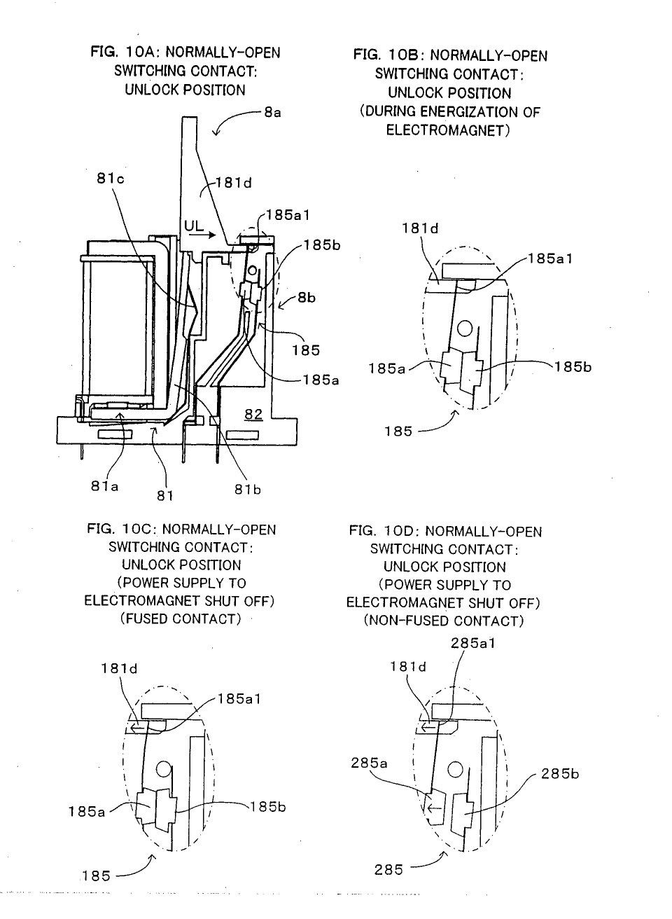

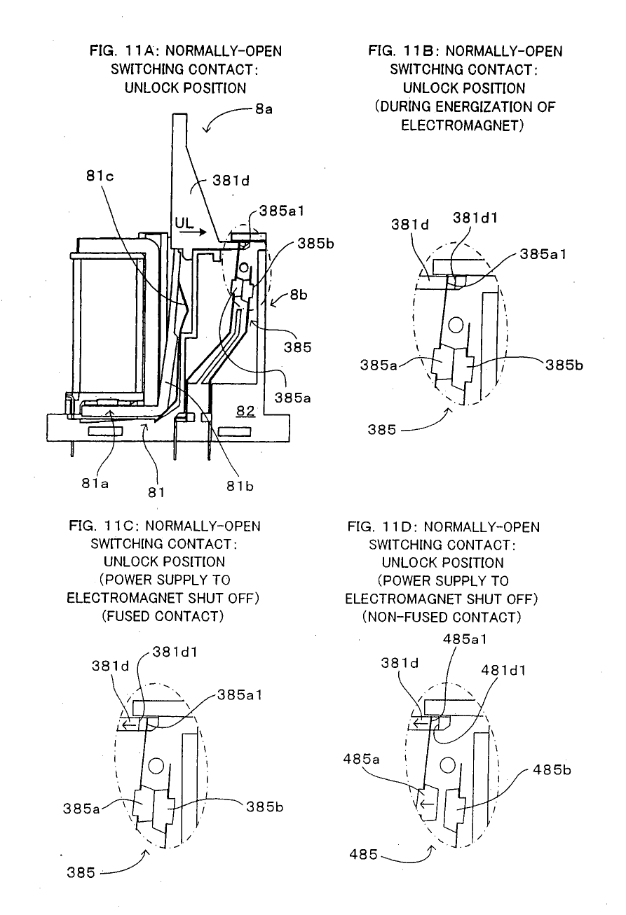

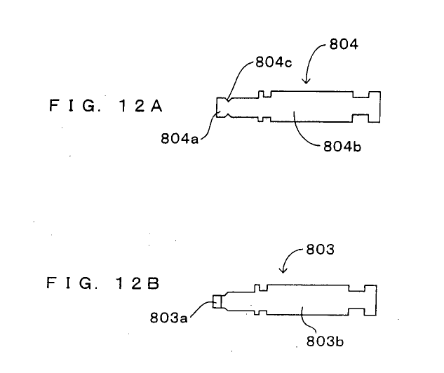

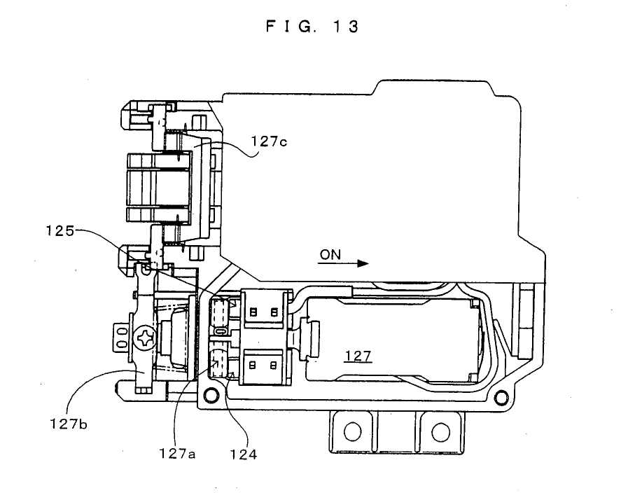

A configuration is possible in which two normally-open switching contacts are provided aligned in the lock switching contact section 8b as shown in FIGS. 10A and 11D. Other configuration and operations are similar to those of the foregoing third and fourth embodiments, and the corresponding reference numerals are assigned and explanation thereof is omitted. It should be noted that FIGS. 10B, 10C, 10D and 11B, 11C and 11D are enlarged views of the portion enclosed with a dashed-dotted line in FIGS. 10A and 11A in different conditions. With such a configuration, the open-close conditions of these normally-open switching contacts are opposite to those of the normally-closed switching contacts in the foregoing third and fourth embodiments. When fusion occurs to the contact of any one of the normally-open switching contacts, as in the foregoing third and fourth embodiments, the open-close condition of the other normally-open switching contact is reliably switched. Therefore, it is possible to reliably determine whether the hinge-type electromagnet 81a is energized as a result of external control, or any problem has occurred to the lock switching contact section 8b, by simultaneously monitoring the open-close conditions of the normally-open switching contacts. Specifically, when the open-close conditions of the normally-open switching contacts 385 and 485 are opposite, it is possible to determine that a problem has occurred to one of the normally-open switching contacts 385 and 485, and the effect similar to the third and fourth embodiments can be achieved.

Furthermore, the lock member is not limited to the above-explained configuration, and for example, the various changes can be added as illustrated in FIGS. 12A and 12B. It should be noted that FIGS. 12A and 12B illustrates lock members. A lock member 804 shown in FIG. 12A includes a base 804b and a tip section 804a connected to the base 804b, and for example, a deficiency section 804c of a groove shape is formed in order to reduce fracture strength at a boundary portion between the tip section 804a and the base 804b. Furthermore, a lock member 803 shown in FIG. 12B includes a base 803b and a tip section 803a connected to the base 803b, and the tip section 803a is formed by attachment to the base 803b. At this time, the base 803b and the tip section 803a can either be made of the same material or different material. With such a configuration, when the actuator is forcibly extracted from the main unit of the safety switch, the tip section of the lock member, and not the notch cut-out section of the drive cam, can be broken in a sure and reliable manner. It should be noted that, in a condition in which the above-explained deficiency section is provided, it is naturally acceptable for the configuration to bond the base and the tip section.

It should be noted that the present invention is not restricted to the foregoing embodiments, and as long as there is no departure from the gist thereof, a variety of changes may be added to the above-explained configurations. For example, one of the normally-closed switching contacts provided in the switching contact section 70 may be a normally-open switching contact. In such a case, the normally-closed switching contact can be used for control of operation of an external device, and the normally-open switching contact can be a switching contact for obtaining an electrical signal for detection of entry of the actuator. With such a configuration, while the normally-closed switching contact becomes a closed condition pursuant to entry of the actuator and the external device changes from an inoperable condition to an operable condition, the normally-open switching contact becomes an open condition pursuant to entry of the actuator. In this way, in addition to entry and withdrawal of the actuator, it is possible to confirm a condition of the external device from the exterior by monitoring the open-close condition of the normally-open switching contact, which performs an opposite open-close operation to the normally-closed switching contact.

Furthermore, although two normally-closed switching contacts are provided in the switching contact section 70 in the foregoing embodiments, there is no restriction to this, and 1, 3, or 4 or more contacts can be provided. It should be noted that at least two normally-closed switching contacts are preferably provided in the switching contact section 70 in order to improve safety-switch reliability. Furthermore, as the second normally-closed switching contact 40 is configured so as to be capable of being switched to a normally-open switching contact by changing the position of the movable contact 40a and the fixed contact 40b, the configuration of the switching contact of the switch section 7 can be easily changed in accordance with intended use.

At this time, it is sufficient only to change the positions of the movable contact 40a and the fixed contact 40b when the second normally-closed switching contact 40 is switched to a normally-open switching contact, and there is no need for special components in each switching contact structure. Therefore, cost can be reduced, and in addition, it is possible to avoid incorrect assembly of components, etc. due to increase in the number of components. It should be noted that, although the foregoing embodiments are configured such that the second normally-closed switching contact 40 alone is capable of switching the switching contact structure thereof, there is no restriction to this, and the number of switching contacts capable of switching the switching contact structure thereof is arbitrary.

Furthermore, in the above-explained first and second embodiments, although the lock member 80 is moved to the lock position by a spring load (urging force) of the return spring 81c and the lock member 80 is moved to the unlock position by an electromagnetic force of attraction generated when the hinge-type electromagnet 81a is in an energized condition, the lock member 80 may be moved to the lock position using this electromagnetic force of attraction so as to put the lock mechanism 8a in a locked state. In this case, for example, it is preferable that a return spring be arranged such that an urging force is directed so as to move the lock member 80 to the unlock position.

In addition, in the above-described first and second embodiments, while the lock member 80 is moved by connecting the working member 81b to the link member 81d as a transmission section of the present invention, the electromagnetic force of attraction of the hinge-type electromagnet may be of course transmitted to the lock member 80 by directly engaging the working member 81b with the lock member 80 without using the link member 81d.

Also, in the above-described embodiments, two normally-open and normally-closed switching contacts are provided in the lock switching contact section 8b as lock mechanism side switching contacts. However, there is no limitation to this, and at least one switching contact is necessary.

In addition, a configuration is possible in which the hinge-type electromagnet is disposed such that the direction of the central axis thereof is substantially parallel to the motion direction of the lock member 80, the working member is attracted by the energized electromagnet and displaced in the same direction as the attracted direction, the transmission section further includes a urging member (such as coil spring) for urging the working member in the direction opposite to the attracted direction of the working member, and the working member is attracted to the electromagnet against the urging force of the urging member. With such a configuration, displacement of the working member that moves against the urging force of the urging member due to the electromagnetic force of attraction generated by energizing the electromagnet can be transmitted to the lock member via the transmission section so as to move the lock member. When a power supply to the electromagnet is shutoff and the electromagnetic force of attraction is lost, the urging member urges the working member so as to restore the displacement of the working member, and as a result the lock member can be moved in the direction opposite to that during energization to the electromagnet. Therefore, since it is possible to move the lock member so as to engage with and disengage from the notch cut-out section formed in the outer peripheral surface of the drive cam using a hinge-type electromagnet, which is more compact than a plunger electromagnet, the safety switch can be downsized.

### INDUSTRIAL APPLICABILITY

It should be noted that the present invention is not restricted to the foregoing embodiments, and as long as there is no departure from the gist thereof, a variety of changes may be added to the above-explained items; furthermore, it may be widely applied in assuring the safety of workers by preventing machinery from being driven when a protective door is not completely closed.

1. A safety switch provided with an actuator capable of freely entering/withdrawing from an operation section of a switch main unit, in which a switch section side switching contact becomes an open condition/a closed condition as result of an operating rod provided in a switch section reciprocating in response to the entry/withdrawal of said actuator, so that the entry/withdrawal of said actuator is detected, the safety switch comprising:
a drive cam provided in said operation section and capable of freely rotating; and
a lock mechanism provided in a lock mechanism section of said switch main unit that locks rotation of said drive cam, wherein
said drive cam rotates forward and backward in response to the entry/withdrawal of said actuator with respect to said operation section, and said operating rod reciprocates due to the forward and backward rotation, and
said lock mechanism comprises:
a lock member provided capable of freely moving between a lock position and an unlock position, that moves to said lock position when said actuator is in the entry condition so as to lock the rotation of said drive cam, and moves to said unlock position so as to release the locked state of the rotation of said drive cam;
a drive section that moves said lock member;
at least one lock mechanism side switching contact; and
a link member that switches an open-close condition of said lock mechanism side switching contact in a manner coupled with the motion of said lock member.

2. The safety switch of claim 1, wherein
said lock mechanism comprises two or more said lock mechanism side switching contacts; and
said link member is provided connecting said lock member and respective movable contacts of said lock mechanism side switching contacts.

3. The safety switch of claim 2, wherein
said lock mechanism comprises a normally-open switching contact and a normally-closed switching contact as said two or more lock mechanism side switching contacts; and
said link member is provided connecting said lock member and respective movable contacts of said normally-open switching contact and said normally-closed switching contact.

4. The safety switch of any of claim 1 to claim 3, wherein said drive section comprises:
a hinge-type electromagnet provided in said lock mechanism section, with a working member displaced due to electromagnetic force of attraction generated by energization, and
a transmission section that moves said lock member by transmitting the displacement of said working member to said lock member.

5. The safety switch of claim 4, wherein said link member functions as said transmission section, said working member engages with a part of said link member, the displacement of said working member is transmitted to said lock member and said lock mechanism side switching contacts via said link member.

6. The safety switch of any of claim 1 to claim 3, wherein
said switch main unit has a rectangular parallelepiped shape, and an actuator entry opening is formed at one of a pair of opposing corner portions of said switch main unit, and a cable extraction opening is formed at the other, and
a cable is extracted from said cable extraction opening substantially in a direction of joining said pair of opposing corner portions.
